(19) United States
(12) Patent Application Publication
(10) Pub. No.: US 2006/0132097 A1
(43) Pub. Date: Jun. 22, 2006

(54) Smart battery simulator

(76) Inventors: Chi-Hao Chiang, Tai-Ping City (TW); Feng-Ming Shen, Hsin-Ying City (TW)

Correspondence Address: Law Office of Kenneth C. Brooks, P.O. Box 10417, Austin, TX, 78766-1417, US

(21) Appl. No.: 11/018,664

(22) Filed: Dec. 21, 2004

(51) Int. Cl. H02J 7/04

(52) U.S. Cl. 320/150

(57) ABSTRACT

A smart battery simulator, which is suitable for use when testing response of an embedded controller of a portable electronic device to different battery conditions, includes a microprocessor. The microprocessor is coupled to the embedded controller of the portable electronic device, and is operable so as to receive an input signal representative of battery-specific test characteristics, so as to generate an output signal that corresponds to the input signal and that is to be provided to the embedded controller of the portable electronic device, and so as to monitor response of the embedded controller of the portable electronic device to the input signal.

### BACKGROUND OF THE INVENTION

1. Field of the Invention

The invention relates to a battery simulator, more particularly to a smart battery simulator.

2. Description of the Related Art

Smart batteries are used in many existing portable electronic devices. Typically, the smart battery provides the portable electronic device with its residual capacity information. The portable electronic device includes an embedded controller that receives the residual capacity information of the battery. Thereafter, the portable electronic device performs power management in accordance with the residual capacity information received by the embedded controller of the portable electronic device.

It is therefore important to test whether the embedded controller of the portable electronic device is functioning properly. A conventional method of testing the embedded controller of the portable electronic device includes the steps of charging and discharging of the smart battery, and operating the portable electronic device to determine the response of the embedded controller of the portable electronic.

However, since the charging/discharging operation of the smart battery is a relatively slow process, this approach for testing the embedded controller of the portable electronic device requires a considerable amount of time to complete.

### SUMMARY OF THE INVENTION

Therefore, the object of the present invention is to provide a smart battery simulator that can be applied to shorten the time required to complete testing of an embedded controller of a portable electronic device.

According to the present invention, a smart battery simulator, which is suitable for use when testing response of an embedded controller of a portable electronic device to different battery conditions, comprises a microprocessor. The microprocessor is adapted to be coupled to the embedded controller of the portable electronic device, and is operable so as to receive an input signal representative of battery-specific test characteristics, so as to generate an output signal that corresponds to the input signal and that is to be provided to the embedded controller of the portable electronic device, and so as to monitor response of the embedded controller of the portable electronic device to the input signal.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a smart battery simulator according to the present invention; and

FIG. 2 is a schematic block diagram illustrating the preferred embodiment in a state of use.

### DETAILED DESCRIPTION OF THE PREFERRED EMBODIMENT

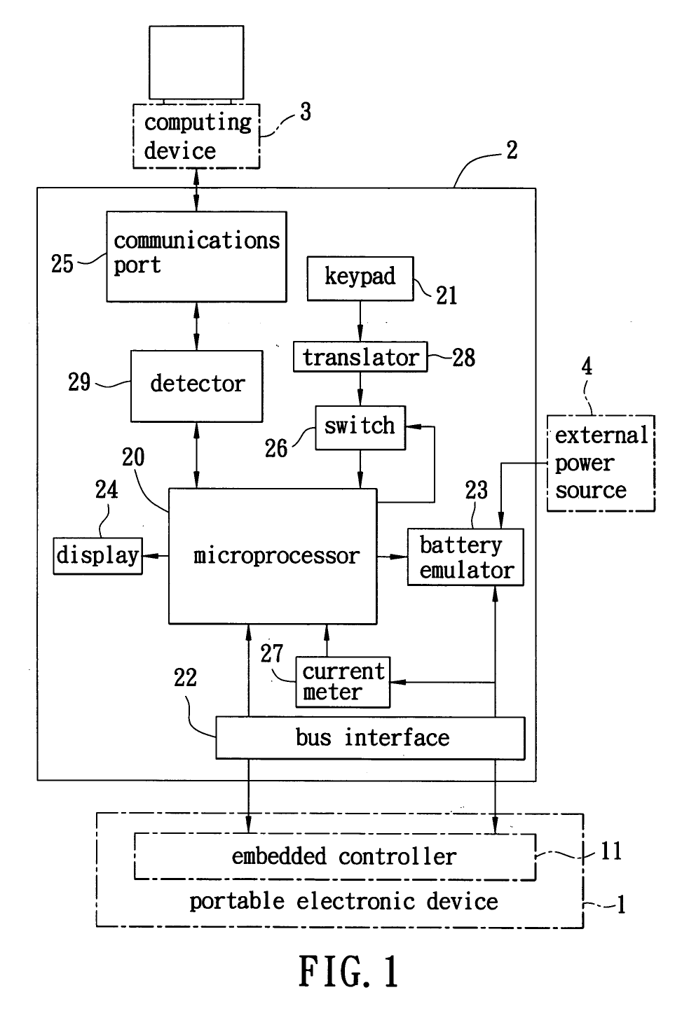

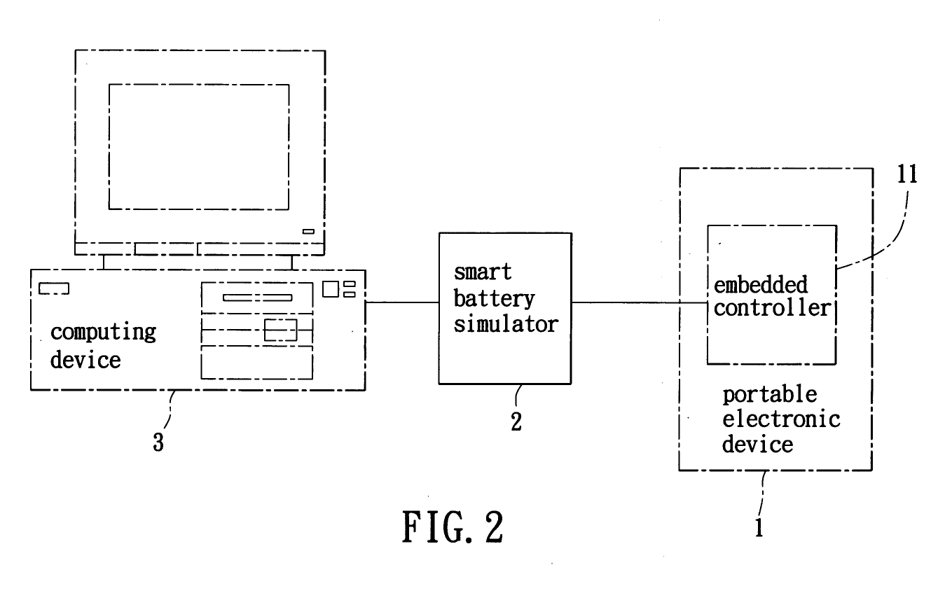

Referring to FIGS. 1 and 2, the preferred embodiment of a smart battery simulator 2 according to this invention is shown to include a microprocessor 20.

The smart battery simulator 2 of this embodiment is suitable for use when testing response of an embedded controller 11 of a portable electronic device 1 to different battery conditions, in a manner that will be described hereinafter.

It is noted that the portable electronic device 1 may be a notebook computer, a mobile phone, or a personal digital assistant (PDA).

The microprocessor 20 is coupled to the embedded controller 11 of the portable electronic device 1. In this embodiment, the microprocessor 20 is operable so as to receive an input signal representative of battery-specific test characteristics, so as to generate an output signal that corresponds to the input signal and that is to be provided to the embedded controller 11 of the portable electronic device 1, and so as to monitor response of the embedded controller 11 of the portable electronic device 1 to the input signal.

The battery-specific test characteristics include a battery voltage, charging control data, and temperature control data.

The smart battery simulator 2 further includes a user input unit coupled to the microprocessor 20, and operable so as to provide the input signal to the microprocessor 20. In particular, the user input unit includes a keypad 21 and a translator 28. The keypad 21 is coupled to the microprocessor 20, and is operable so as to input the battery-specific test characteristics. The translator 28 is coupled between the keypad 21 and the microprocessor 20, and is operable so as to translate the battery-specific test characteristics inputted through the keypad 21 into the input signal that is provided to the microprocessor 20.

The smart battery simulator 2 further includes a communications port 25, a detector 29, and a switch 26. The communications port 25, preferably a RS-232 serial interface, is coupled to the microprocessor 20 and a computing device 3. The microprocessor 20 receives the input signal from the computing device 3 through the communications port 25. The detector 29 is coupled between the microprocessor 20 and the communications port 25, and is operable so as to detect receipt of the input signal from the computing device 3. The switch 26 is coupled between the microprocessor 20 and the translator 28 of the user input unit. In this embodiment, the switch 26 is operable in anon state, where the switch 26 connects the microprocessor 20 to the translator 28 when the detector 29 does not detect the receipt of the input signal from the computing device 3, and in an off state, where the switch 26 disconnects the microprocessor 20 from the translator 28 of the user input unit when the detector 29 detects receipt of the input signal from the computing device 3. The microprocessor 20 is further operable so as to control operation of the switch 26 between the on and off states.

The smart battery simulator 2 further includes a battery emulator 23 coupled to the microprocessor 20 and the embedded controller 11 of the portable electronic device 1, and an external power source 4. In this embodiment, the battery emulator 23 is operable in a discharging mode, where the battery emulator 23 generates a discharge current that is to be supplied to the embedded controller 11 of the portable electronic device 1, and in a charging mode, where the battery emulator 23 draws a charge current from the embedded controller 11 of the portable electronic device 1.

It is noted that the battery-specific test characteristics further include battery emulator control data. The microprocessor 20 is further operable so as to control the operation of the battery emulator 23 between the discharging and charging modes in accordance with the battery emulator control data. As such, the duration at which the battery emulator 23 operates in the charging or discharging mode is under the control of the test personnel (not shown).

The smart battery simulator 2 further includes a current meter 27 coupled between the microprocessor 20 and the battery emulator 23. In this embodiment, the current meter 27 is operable so as to measure the discharge current supplied by the battery emulator 23 to the embedded controller 11 of the portable electronic device 1 when the battery emulator 23 is operated in the discharging mode.

The microprocessor 20 is further operable so as to adjust the discharge current supplied by the battery emulator 23 to the embedded controller 11 of the portable electronic device 1 in accordance with the discharge current measured by the current meter 27.

It is noted that the embedded controller 11 of the portable electronic device 1 likewise measures the discharge current supplied by the battery emulator 23 to the embedded controller 11 of the portable electronic device 1. As such, when the current meter 27 is inoperative, the microprocessor 20 is able to adjust the discharge current supplied by the battery emulator 23 to the embedded controller 11 of the portable electronic device 1 in accordance with the discharge current measured by the embedded controller 11 of the portable electronic device 1.

In an alternative embodiment, the microprocessor 20 is further operable so as to compute the average value of the discharge current measured by the current meter 27 and the discharge current measured by the embedded controller 11 of the portable electronic device 1. The microprocessor 20 then adjusts the discharge current supplied by the battery emulator 23 to the embedded controller 11 of the portable electronic device 1 in accordance with the average discharge current computed thereby.

The smart battery simulator 2 further includes a bus interface 22 coupled to the microprocessor 20 and the embedded controller 11 of the portable electronic device 1. The microprocessor 20 provides the output signal to and receives the discharge current measured by the embedded controller 11 of the portable electronic device 1 through the bus interface 22. The battery emulator 23 supplies the discharge current to and draws the charge current from the embedded controller 11 of the portable electronic device 1 through the bus interface 22. Preferably, the bus interface 22 is a system management (SM) bus.

The smart battery simulator 2 further includes a display 24 coupled to and controlled by the microprocessor 20 so as to show the battery-specific test characteristics thereon. Preferably, the display 24 is a seven-segment display.

In use, to test whether the embedded controller 11 of the portable electronic device 1 is functioning properly, the smart battery simulator 2 of this embodiment may be operated in a manual or automatic test mode. In the manual test mode, the user input unit is operated to provide the input signal to the microprocessor 20. Thereafter, the portable electronic device 1 is operated to determine the response of the embedded controller 11 of the portable electronic device 1 to the input signal. In the automatic test mode, the microprocessor 20 is operated to receive the input signal from the computing device 3 through the communications port 25. Thereafter, the computing device 3 is operated to analyze the response of the embedded controller 11 of the portable electronic device 1 to the input signal as monitored by the microprocessor 20. It is noted the in the manual test mode, the microprocessor 20 may receive the input signal from the computing device 3. Moreover, in the automatic test mode, the computing device 3 may be operated to perform automatic repeated testing.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A smart battery simulator suitable for use when testing response of an embedded controller of a portable electronic device to different battery conditions, said smart battery simulator comprising:
a microprocessor adapted to be coupled to the embedded controller of the portable electronic device, and operable so as to receive an input signal representative of battery-specific test characteristics, so as to generate an output signal that corresponds to the input signal and that is to be provided to the embedded controller of the portable electronic device, and so as to monitor response of the embedded controller of the portable electronic device to the input signal.

2. The smart battery simulator as claimed in claim 1, further comprising a user input unit coupled to said microprocessor and operable so as to provide the input signal to said microprocessor.

3. The smart battery simulator as claimed in claim 2, wherein said user input unit includes a keypad for inputting the battery-specific test characteristics.

4. The smart battery simulator as claimed in claim 3, wherein said user input unit further includes a translator that is coupled between said keypad and said microprocessor and that is operable so as to translate the battery-specific test characteristics inputted through said keypad into the input signal that is provided to said microprocessor.

5. The smart battery simulator as claimed in claim 2, further comprising:
a communications port coupled to said microprocessor and adapted to be coupled to a computing device so as to receive the input signal therefrom;
a detector coupled between said microprocessor and said communications port, and operable so as to detect receipt of the input signal from the computing device; and
a switch coupled between said microprocessor and said user input unit, and operable so as to disconnect said microprocessor from said user input unit when said detector detects receipt of the input signal from the computing device.

6. The smart battery simulator as claimed in claim 5, wherein said communications port is a RS-232 serial interface.

7. The smart battery simulator as claimed in claim 1, further comprising a communications port coupled to said microprocessor and adapted to be coupled to a computing device so as to receive the input signal therefrom.

8. The smart battery simulator as claimed in claim 7, wherein said communications port is a RS-232 serial interface.

9. The smart battery simulator as claimed in claim 1, further comprising a battery emulator coupled to said microprocessor, and adapted to be coupled to an external power source and the embedded controller of the portable electronic device, said battery emulator being operable in a discharging mode, where said battery emulator generates a discharge current that is to be supplied to the embedded controller of the portable electronic device.

10. The smart battery simulator as claimed in claim 9, wherein said battery emulator is further operable in a charging mode, where said battery emulator draws a charge current from the embedded controller of the portable electronic device.

11. The smart battery simulator as claimed in claim 9, further comprising a current meter coupled between said microprocessor and said battery emulator, and operable so as to measure the discharge current supplied by said battery emulator to the embedded controller of the portable electronic device when said battery emulator is operated in the discharging mode, said microprocessor being further operable so as to adjust the discharge current supplied by said battery emulator to the embedded controller of the portable electronic device in accordance with the discharge current measured by said current meter.

12. The smart battery simulator as claimed in claim 1, further comprising a display coupled to and controlled by said microprocessor so as to show the battery-specific test characteristics thereon.

13. The smart battery simulator as claimed in claim 12, wherein said display is a seven-segment display.

14. The smart battery simulator as claimed in claim 1, wherein the battery-specific test characteristics include at least one of a battery voltage, charging control data, and temperature control data.
